(19) United States
(12) Patent Application Publication
(10) Pub. No.: US 2022/0217965 A1
(43) Pub. Date: Jul. 14, 2022

(54) BOOM FOR AN AGRICULTURAL CROP SPRAYER AND METHOD OF MANUFACTURE

(71) Applicant: AGCO do Brasil Soluções Agrícolas Ltda., Ribeirao Preto (BR)

(72) Inventor: Marcos Pedrollo Soliman, Canoas (BR)

(21) Appl. No.: 17/761,575

(22) PCT Filed: Sep. 9, 2020
(86) PCT No.: PCT/IB2020/058359

§ 371 Date: Mar. 17, 2022

(30) Foreign Application Priority Data
Sep. 18, 2019 (GB) 1913473.3

(51) Int. Cl. A01M 7/00

(52) U.S. Cl. CPC A01M 7/0071; A01M 7/006

(57) ABSTRACT

A boom for an agricultural crop sprayer has an elongate triangular box arrangement that is load bearing and serves to carry liquid dispensing devices for the application of crop protection products. The box arrangement includes three elongate plates each formed preferably from a carbon fiber material. The plates may be secured together by bolts or rivets by three connecting members that each present elongate edges of the box arrangement.

### CROSS-REFERENCE TO RELATED APPLICATIONS

This application is a national phase entry under 35 U.S.C. § 371 of International Patent Application PCT/IB2020/058359, filed Sep. 9, 2020, designating the United States of America and published in English as International Patent Publication WO 2021/053461 A1 on Mar. 25, 2021, which claims the benefit of United Kingdom patent application No. GB1913473.3, filed on Sep. 18, 2019, “BOOM FOR AN AGRICULTURAL CROP SPRAYER AND METHOD OF MANUFACTURE,” the entire disclosure of each of which is hereby incorporated by reference.

### TECHNICAL FIELD

The disclosure relates to the construction of booms for agricultural sprayers used for the application of plant protection products to crop fields.

### BACKGROUND

Agricultural sprayers are used by farmers and contractors to apply pesticides and other nutrient-containing solutions to crop fields. Sprayers can be mounted to, or towed by, a tractor or other suitable vehicle, or may be self-propelled with an integrated means of propulsion and a driver's cab. The sprayer machine typically includes a storage tank for the liquid to be applied, the tank being filled as required by the operator.

The liquid is applied to the field by a number of liquid application devices, typically spray nozzles, which are mounted in a spaced relationship along the length of a boom which, itself, is mounted to the sprayer vehicle. The nozzles are each connected to the storage tank by liquid delivery means comprising various pipes, valves, pumps, and other plumbing. The liquid is atomized by the nozzles and applied to the crop in a jet of mist for example.

The length of the boom determines the operating width of the sprayer. A sprayer will typically have mounted thereto two identical booms that extend transversely to either side of the sprayer. Driven by economies of scale, there is a growing demand for sprayer manufacturers to produce machines with longer spray booms. All but the smallest of models comprise a folding multi-section boom which folds for transport. Increasing the boom length significantly increases the risk of structural failure due to the increased stress placed upon the hinges and joints caused by natural vibrations and oscillations which pass from the spray vehicle along the boom. Moreover, to avoid inaccurate application of chemicals, the oscillations should be minimized.

The stiffness-to-weight ratio of the boom needs to be sufficient to resist the bending forces the boom is subjected to during motion. With common materials such as aluminum and steel, this has proven unachievable for boom lengths greater than 36 meters. Lighter and stronger materials such as composites including carbon fiber may achieve the desired stiffness-to-weight ratio but carry significant additional cost which makes their use commercially unviable. For example, one problem with employing carbon fiber for booms is the high cost associated with manufacturing complex structures. Furthermore, repairing damaged booms formed from carbon fiber commonly requires complete replacement, which is expensive.

Yet there remains a desire to exploit the favorable properties of composite materials while minimizing the associated cost increase. It is therefore one object of the disclosure to provide a boom having a construction which accommodates lighter and/or stronger materials without significantly increasing the cost of manufacturing or maintaining the overall boom.

### BRIEF SUMMARY

In some embodiments, a boom for an agricultural crop sprayer has a tubular structure with a rounded triangular section that extends from a first boom end to a second boom end. The tubular structure has three plates fastened together by three curved connecting members. The flat plates are formed from a first material, and the curved members are formed from a second material different from the first material.

In another embodiment, a method of manufacturing a crop sprayer boom includes fastening three plates together with three curved connecting members to form a tubular structure with a rounded triangular section that extends from a first boom end to a second boom end. The plates are formed from a first material, and the curved members are formed from a second material different from the first material.

This provides a simple yet strong construction that can exploit the advantages delivered by different materials having different properties. The tubular structure with rounded triangular section that extends along the length of the boom provides functional strength and simplicity in assembly. The rounded corners of the triangular section are provided by the connecting members and deliver greater strength and rigidity compared to straight corners.

Fabricated using two different materials, the boom can exploit both the strength of composite materials in places where it delivers optimum benefit and the low cost of more conventional materials.

It should be understood that the term ‘boom’ is used herein in relation to an assembly that can form a single boom section of a multi-section boom arrangement for attachment to an agricultural sprayer.

The plates are preferably substantially flat and elongate. It should be understood that the plates, although substantially flat, may be contoured to an extent to increase strength and reduce the risk of buckling.

In some embodiments, the plates are formed from a composite material, such as a carbon fiber-based composite, whereas the curved connecting members are formed from a more conventional material such as steel or aluminum.

The non-complex structure is simple to manufacture and repair. The plates are preferably rectangular and may have cut-outs formed therein to further reduce weight and material cost. With little in the way of processing required for the plates, the high costs associated with complex structures made from carbon fiber material are thus avoided.

The provision of separate plates and connecting members also facilitates easier and cheaper repair in the event of damage to a part of the boom compared to molded booms.

The connecting members may be formed from a cheaper material that is easier to bend, roll, and/or machine such as steel or aluminum. Each connecting member provides a joint along a respective elongate edge of the tubular structure between an adjacent two of the three plates. At least one, and preferably all, of the three connecting members is preferably fastened between a respective two of the three plates by one of bolts and rivets so as to offer simple disassembly in the event of a repair. In an alternative embodiment, the plates and connecting members may be fastened using adhesive, which advantageously reduces part count and further simplifies assembly. In another alternative, the plates and connecting members are welded together.

In a preferred embodiment, a first one of the three plates is a base plate which resides at the bottom of the triangular section when the boom is attached to an agricultural crop sprayer. Dispensing nozzles are mounted to the boom and configured to dispense liquid in a generally downward direction. The other two plates preferably present longer sides in terms of the triangular section thus presenting an isosceles triangle, albeit with rounded corners.

An end element is preferably provided and disposed inside the tubular structure at one end thereof. The end element is mated to the three plates by bolts or rivets. The end element provides a structure to which other sections of a multi-section boom can be mounted. The end element is preferably secured to the triangular box arrangement by bolts or rivets that extend through the plates. Alternatively, the end element may be glued or welded in place.

### BRIEF DESCRIPTION OF THE DRAWINGS

Further advantages will become apparent from reading the following description of specific embodiments with reference to the appended drawings in which:

FIG. 1 is a schematic side view of a tractor and trailed sprayer fitted with a multi-section boom;

FIG. 2 is a schematic plan view of the tractor and sprayer of FIG. 1, showing the boom in an unfolded configuration in solid lines and in a folded configuration in dashed lines;

FIG. 3 is a schematic rear view of the boom of FIG. 2 in the unfolded configuration;

FIG. 4 is a perspective view of one boom section;

FIG. 5 is an end view of the tubular structure forming part of the boom section of FIG. 4, shown with one connecting member in exploded form;

FIG. 6 is a perspective view of an end member of the boom section of FIG. 4; and

FIG. 7 is a perspective view of an end portion of the boom section of FIG. 4, showing the end member in exploded form.

### DETAILED DESCRIPTION

The following detailed description references the drawings, wherein certain embodiments are described in detail. Although described with reference to these specific preferred embodiments, it will be understood that the disclosure is not limited to these preferred embodiments. But to the contrary, numerous alternatives, modifications, and equivalents will become apparent from consideration of the following detailed description.

Reference to terms such as longitudinal, transverse, and vertical are made with respect to a longitudinal vehicle axis which is parallel to a normal forward direction of travel.

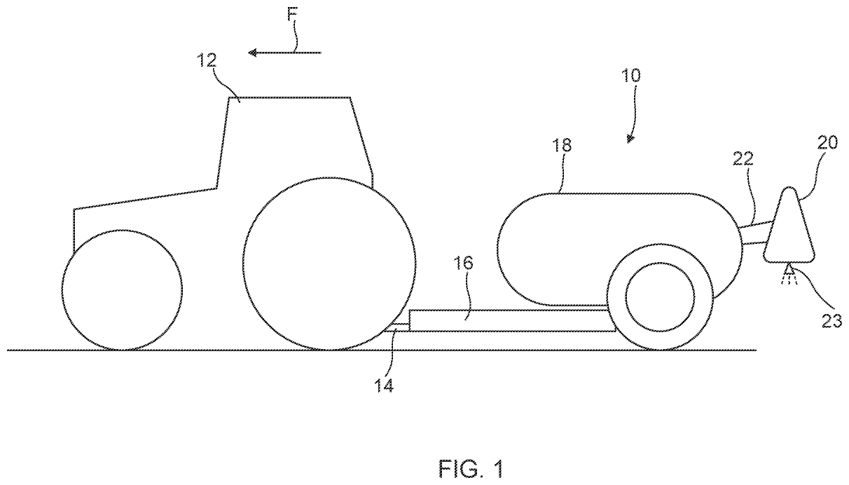

With reference to FIGS. 1, 2, and 3, a trailed agricultural sprayer 10 is represented in schematic form from various views. The sprayer 10 is attached to the rear of a tractor 12 by means of a towing hitch 14 associated with the tractor and a drawbar tongue 16 forming part of the chassis of the sprayer 10. The sprayer 10 includes a storage tank 18 to store the liquid material to be applied to a crop field.

A transversely-extending multi-section boom 20 is formed from five separate boom sections 20a to 20e which are connected by hinges and aligned with one another in the operating configuration shown. In this configuration, the boom 20 extends substantially at right angles to the forward direction of travel, represented by arrow F in FIG. 1.

A central boom section 20c is fixed to the rear of the sprayer 10 by a suitable linkage represented at 22. As in known sprayer machines, the linkage 22 may permit raising and lowering of the boom 20 to adapt to different crops and conditions.

The boom 20 further comprises a left-hand boom assembly and a right-hand boom assembly each hingedly mounted to respective ends of the central boom section 20c for pivoting movement around a substantially vertical axis. Left-hand boom assembly comprises an inner boom section 20b mounted to the central boom section 20c and an outer boom section 20a hindegly connected to the inner boom section 20b. Right-hand boom assembly comprises an inner boom section 20d mounted to the central boom section 20c and an outer boom section 20e hingedly connected to the inner boom section 20d.

It should be appreciated that a multi-section boom may have more or fewer boom sections than the five boom sections shown in FIG. 1. For example, in a common alternative, each side boom assembly may include an inner boom section hinged to the center boom section, a mid boom section hinged to an outboard end of the inner boom section, and a boom tip section pivotably mounted to an outboard end of the mid boom section by a breakaway joint.

Turning back to the illustrated embodiment, liquid dispense devices 23 in the form of nozzles, for example, are mounted to the boom in a spaced relationship across the working width. During a spraying operation, liquid stored in the tank 18 is conveyed to the dispense devices 23 by a liquid delivery network (not shown) and applied to the field by the dispense devices 23 in a generally downward direction. Liquid delivery networks are known in the art and will not be described in any detail here. It should be understood that although only nine dispense devices 23 are shown in the drawings, the number used will depend on the boom length and desired spacing.

The pivoting connections between the respective boom sections 20a-20e allow the multi-section boom 20 to be folded into a transport configuration represented schematically by dashed lines 20′. It should be recognized that the folding mechanism and construction of the boom 20 is shown in highly schematic form in FIGS. 1-3.

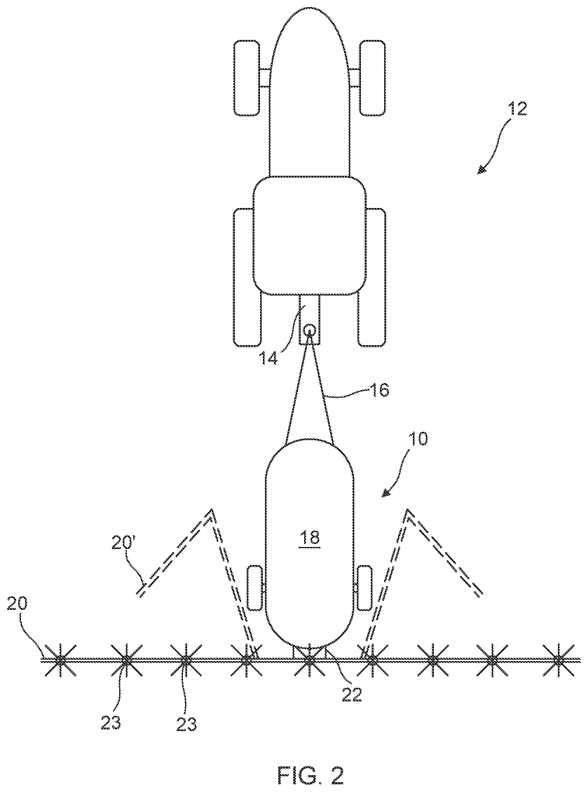

The construction of a boom (or boom section) is described as mounted to an agricultural sprayer such as that shown in FIGS. 1 and 2. It should be understood that the boom construction described hereinafter can be used in conjunction with different types of agricultural sprayer including mounted, trailed, and self-propelled.

The following description makes reference to “booms” but it should be understood that the constructions described can be applied to a single boom section of a multi-section boom, and the term “boom” shall encompass “boom section” also.

With reference to FIG. 4, boom section 20b is shown in more detail, and will hereinafter be referred to as boom 20b. Although the following description makes reference specifically to the inner left boom section 20b, it should be appreciated that the same construction may be, and is preferably, followed by the other boom sections 20a, 20d, and 20e (the center boom section 20c is typically of a different construction and integrated with a boom support frame). Moreover, it should be understood that the construction described below with reference to FIGS. 4-7 can be applied to a standalone boom.

The boom 20b has a tubular structure with a rounded triangular section that extends from a first boom end 26 to a second boom end 27. The rounded triangular section can be seen best in FIG. 5. The tubular structure comprises three substantially flat plates 31, 32, 33 fastened together by three curved connecting members 34, 35, 36. The plates 31, 32, 33 form the three sides of the triangular section. The connecting members 34, 35, 36 form the rounded vertices of the triangular section. Both the flat plates 31, 32, 33 and the connecting members 34, 35, 36 are elongate, having a major axis that extends the length of the boom 20b from the first boom end 26 to the second boom end 27. Typically, an inner boom section has a length of 7-8 meters, and a tip section has a length of 3-4 meters.

The plates 31, 32, 33 are fastened together by the connecting members 34, 35, 36 using structural adhesive such as urethane or epoxy adhesive, although bolts, rivets, or welding are alternative means for fastening. In more detail, the upper connecting member 34 extends lengthwise along the apex of the triangular structure and has a continuous curved or arcuate section along the length thereof. The front plate 31 and the rear plate 32 are fastened along respective lengthwise edges 31a, 32a that overlap with front and rear lengthwise edges 34a, 34b of the upper connecting member 34. For the receipt of bolts or rivets, holes 38 may be provided along the edges 31a, 32a, 34a, 34b. The rear connecting member 35 and front connecting member 36 are fastened to adjacent pairs of the flat plates in the same manner. The rear connecting member 35 extends lengthwise along the rearmost vertex of the triangular structure and has a continuous curved or arcuate section along the length thereof. The rear plate 32 and the base plate 33 are fastened along respective lengthwise edges 32b, 33a that overlap with upper and lower lengthwise edges 35a, 35b of the rear connecting member 35. The front connecting member 36 extends lengthwise along the front-most vertex of the triangular structure and has a continuous curved or arcuate section along the length thereof. The base plate 33 and the front plate 31 are fastened along respective lengthwise edges 33b, 31b that overlap with lower and upper lengthwise edges 36a, 36b of the front connecting member 36.

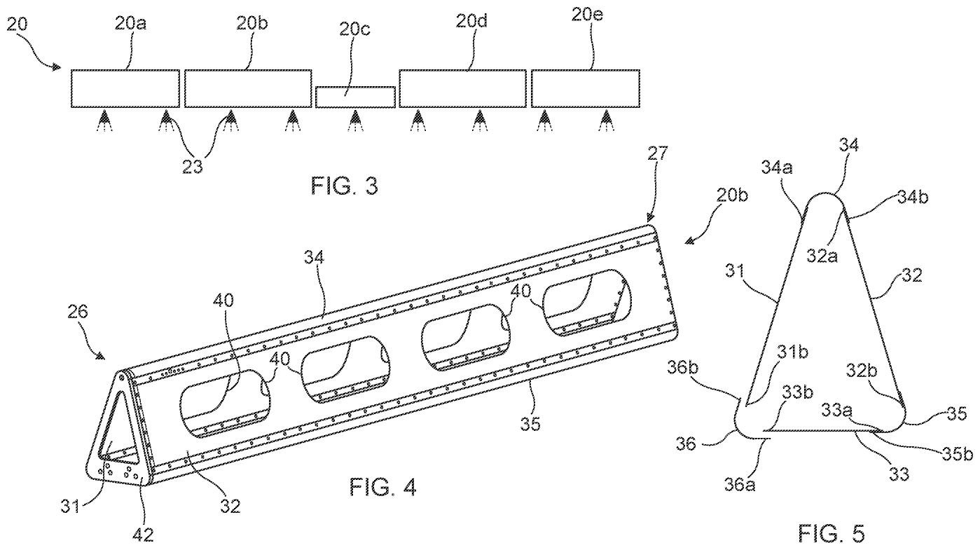

Fastened together, the plates 31, 32, 33 and connecting members 34, 35, 36 provide a hollow, tubular structure which is load-bearing when in operation. In other words, when in a multi-section boom assembly, the tubular structure carries the weight of any outboard boom sections mounted thereto (for example the outer boom section 20a in FIG. 3). In an alternative arrangement not illustrated, the curved connecting members 34, 35, 36 may overlap on the inside of the plates 31, 32, 33.

The flat plates 31, 32, 33 are formed from a first material. The connecting members 34, 35, 36 are formed from a second material that is different from the first material. The first material may be a carbon fiber composite that exhibits strong and stiff characteristics yet is lighter than steel or aluminum, for example. Alternatively, by way of further example, the first material may be an aramid composite, a glass fiber composite, or a hybrid material.

The second material may be steel or aluminum, which is cheaper than composite materials.

Use of a stronger yet lighter material for the flat plates 31, 32, 33 in combination with a cheaper material for the connecting members 34, 35, 36 delivers the benefits of composite materials without adding significant cost.

Cut-outs 40 are provided in the front and rear flat plates 31, 32 to improve accessibility to any plumbing residing within the tubular structure for easier maintenance.

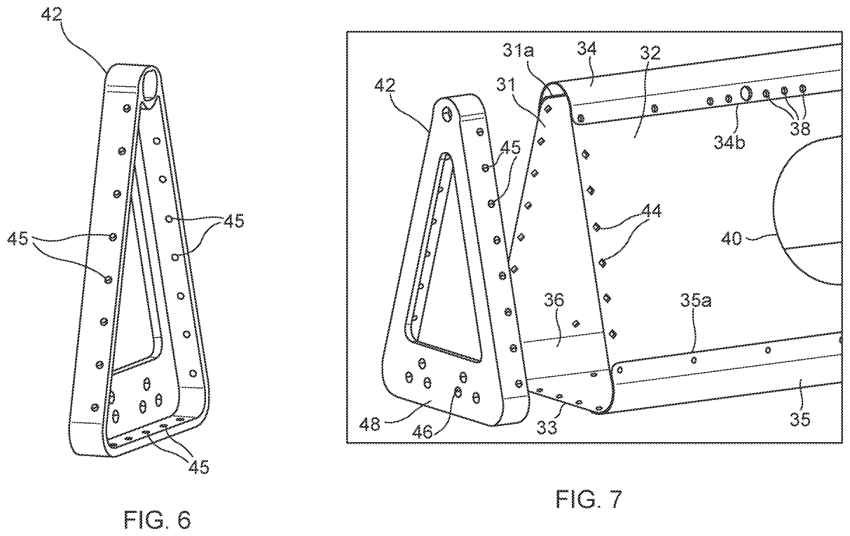

With reference to FIGS. 6 and 7, an end element 42 is nested inside the tubular structure at the first boom end 26. The end element 42 is mated to the three plates 31, 32, 33 and secured in place, preferably by bolts that pass through holes 44 formed in the plates 31, 32, 33 into threaded bores 45 in the end element 42. The end element 42 has an external profile that matches the internal profile of the rounded triangular section of the tubular structure described above.

The end element 42 is preferably a cast or machined component. The end element 42 serves as a mounting plate to which the boom section 20b can be mounted to a center boom frame or to an adjacent boom section. As such, holes 46 may be preformed or drilled in an end face 48 of the end element 42 to facilitate the securing of brackets and the like for hinging to adjacent boom sections or for the attachment of actuators.

While the present disclosure has been described herein with respect to certain embodiments, those of ordinary skill in the art will recognize and appreciate that it is not so limited. Rather, many additions, deletions, and modifications to the illustrated embodiments may be made without departing from the scope of the disclosure as hereinafter claimed, including legal equivalents thereof. Further, embodiments of the disclosure have utility with different and various machine types and configurations.

1. A boom, comprising:
a tubular structure defining a rounded triangular section that extends from a first boom end to a second boom end, the tubular structure comprising three plates fastened together by three curved connecting members, wherein the plates comprise a first material and the curved members comprise a second material different from the first material.

2. The boom of claim 1, wherein the first material comprises carbon fiber.

3. The boom of claim 1, wherein the second material comprises a material selected from the group consisting of steel and aluminum.

4. The boom of claim 1, wherein at least one of the three plates defines a plurality of cut-outs formed therein.

5. The boom of claim 1, wherein at least one of the three connecting members is fastened between a respective two of the three plates by fasteners selected from the group consisting of bolts and rivets.

6. The boom of claim 1, wherein at least one of the three connecting members is fastened between a respective two of the three plates by adhesive.

7. The boom of claim 1, further comprising dispensing nozzles mounted to the boom and configured to dispense liquid.

8. The boom of claim 1, further comprising an end element disposed inside the tubular structure at the first boom end, wherein the end element is mated to the three plates by one selected from the group consisting of bolts, rivets, and adhesive.

9. The boom of claim 8, wherein the end element exhibits an external profile that matches a profile of the triangular section.

10. A multi-section boom arrangement, comprising:
a boom section comprising a tubular structure defining a rounded triangular section that extends from a first boom end to a second boom end, the tubular structure comprising three plates fastened together by three curved connecting members, and an end element disposed inside the tubular structure at the first boom end, wherein the plates comprise a first material and the curved members comprise a second material different from the first material, and
a second boom section hingedly attached to the end element.

11. An agricultural crop sprayer comprising a chassis, a fluid storage tank, and the boom arrangement of claim 10.

12. A method of manufacturing a crop sprayer boom, the method comprising:
fastening three plates together with three curved connecting members to form a tubular structure with a rounded triangular section that extends from a first boom end to a second boom end, wherein the flat plates are formed from a first material and the curved members are formed from a second material different from the first material.

13. The method of claim 12, wherein fastening three plates together with three curved connecting members comprises fastening each of the three connecting members to a respective adjacent pair of the three plates with a fastener selected from the group consisting of bolts and rivets.

14. The method of claim 12, wherein fastening three plates together with three curved connecting members comprises gluing each of the three connecting members to respective adjacent pairs of the three plates.

15. The method of claim 12, further comprising fastening an end element inside the tubular structure.

16. The method of claim 15, wherein fastening an end element inside the tubular structure comprises fastening the end element to the three plates by one selected from the group consisting of bolts, rivets, and adhesive

17. The method of claim 15, further comprising hingedly attaching a second tubular structure to the end element.

18. The method of claim 12, further comprising securing a plurality of nozzles to the tubular structure.

19. An agricultural crop sprayer comprising a chassis, a fluid storage tank, and the boom of claim 1.

20. The agricultural crop sprayer of claim 19, wherein the boom comprises a plurality of boom sections configured to pivot relative to one another.
